(19) United States
(12) Patent Application Publication
(10) Pub. No.: US 2015/0261535 A1
(43) Pub. Date: Sep. 17, 2015

(54) METHOD AND APPARATUS FOR LOW LATENCY EXCHANGE OF DATA BETWEEN A PROCESSOR AND COPROCESSOR

(71) Applicant: Cavium, Inc., San Jose, CA (US)

(72) Inventors: Wilson P. Snyder, II, Holliston, MA (US); Richard E. Kessler, Northborough, MA (US); Michael S. Bertone, Marlborough, MA (US)

(73) Assignee: Cavium, Inc., San Jose, CA (US)

(21) Appl. No.: 14/204,374

(22) Filed: Mar. 11, 2014

(51) Int. Cl. G06F 9/30; G06F 15/76

(52) U.S. Cl. CPC G06F 9/30145; G06F 15/76

(57) ABSTRACT

According to at least one example embodiment, a method of processing a wide command includes storing wide command data in a first physical structure of a processor. Information associated with the wide command is determined based on the wide command data and/or a corresponding memory address range associated with the wide command. The information associated with the wide command determined includes a size of the wide command and is stored in a second physical structure of the processor. The processor causes the wide command data and the information associated with the wide command to be provided directly to a coprocessor for executing the wide command. The processor and the coprocessor may reside on a single chip device. Alternatively, the processor and the coprocessor may reside on separate chip devices in a multi-chip system.

### BACKGROUND

Significant advances have been achieved in microprocessor technology. Such advances have led to increases in processing capabilities of microprocessor chip devices. Among factors contributing to such increase is the use of core processors and coprocessors in the chip device. Coprocessors perform specific processing tasks, e.g., input/output (I/O) operations, compression/decompression tasks, hardware acceleration, work scheduling, etc., and, as such, offload core processors. In performing such tasks, coprocessors are configured to communicate with core processors. Specifically, Coprocessors may receive instructions and/or data from core processors, and may provide results of processing tasks performed to core processors.

### SUMMARY

Core processors are configured to communicate with coprocessors in a same chip device, or in a same multi-chip system, for example, to provide instructions and/or data, and receive results of processing tasks performed by the coprocessors. Instructions provided to coprocessors may be wide command instructions with corresponding size(s) larger than a maximum size associated with an instruction set supported by the core processors. Implementing wide commands between a core processor and a coprocessor, in a chip device or a multi-chip system, involves multiple data transfers, each transferring a data word between the core processor and the coprocessor. As such, a wide command transaction may be interrupted before all data transfers are complete or the whole transaction is complete. In such case, resuming the same wide command transaction later poses challenges to the core processor and the coprocessor in terms of keeping track of what was transferred and what was not.

According to at least one example embodiment, a method and system of processing a wide command comprise storing wide command data in a first physical structure of a processor. Information associated with the wide command is determined based on the wide command data and/or a corresponding memory address range associated with the wide command. The information associated with the wide command determined includes a size of the wide command. The information associated with the wide command is stored in a second physical structure of the processor. The processor then causes the wide command data and the information associated with the wide command to be provided directly to a coprocessor for executing the wide command.

According to at least one aspect, the processor and the coprocessor may reside on a single chip device. Alternatively, the processor and the coprocessor may reside on separate chip devices in a multi-chip system.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a diagram illustrating an architecture of a chip device according to at least one example embodiment; and

FIG. 2 is a block diagram illustrating exchange of data between a core processor and a coprocessor, according to at least one example embodiment.

### DETAILED DESCRIPTION

A description of example embodiments of the invention follows.

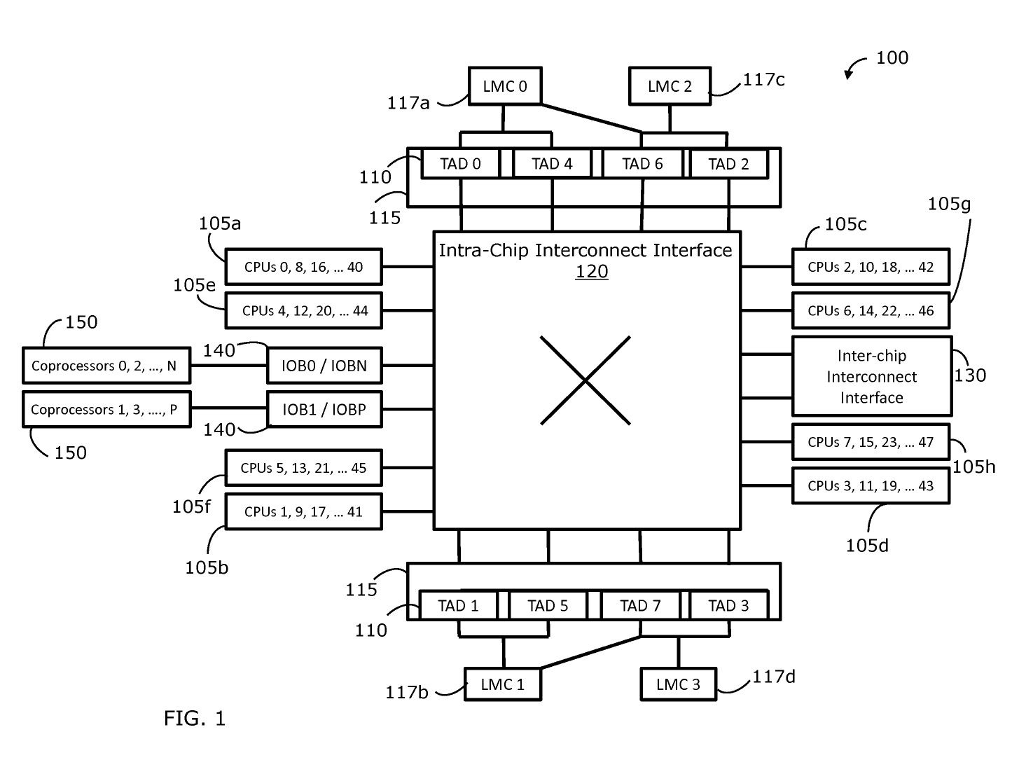

FIG. 1 is a diagram illustrating architecture of a chip device 100 according to at least one example embodiment. In the example architecture of FIG. 1, the chip device includes a plurality of core processors, e.g., 48 core processors. Each of the core processors includes at least one cache memory component, e.g., level-one (L1) cache, for storing data within the core processor. A person skilled in the art should appreciate that a core processor may include multiple levels of cache memory. According to at least one aspect, the plurality of core processors are arranged in multiple clusters, e.g., 105a-105h, referred to also individually or collectively as 105. For example, for a chip device 100 having 48 cores arranged into eight clusters 105a-105h, each of the clusters 105a-105h includes six core processors. The chip device 100 also includes a shared cache memory, e.g., level-two (L2) cache, 110 and a corresponding controller 115 configured to manage and control access of the shared cache memory 110. According to at least one aspect, the shared cache memory 110 is partitioned into multiple tag and data units (TADs). Alternatively, the shared cache memory may not be partitioned. The shared cache memory 110, or the TADs, and the corresponding controller 115 are coupled to one or more local memory controllers (LMCs), e.g., 117a-117d, configured to enable access to an external, or attached, memory, such as, data random access memory (DRAM), associated with the chip device 100.

According to at least one example embodiment, the chip device 100 includes an intra-chip interconnect interface 120 configured to couple the core processors and the shared cache memory 110, or the TADs, to each other through a plurality of communications buses. The intra-chip interconnect interface 120 is used as a communications interface to implement memory coherence and enable communications between different components within the chip device 100. The intra-chip interconnect interface 120 may also be referred to as a memory coherence interconnect interface. According to at least one aspect, the intra-chip interconnect interface 120 has cross-bar (xbar) structure.

According to at least one example embodiment, the chip device 100 further includes one or more coprocessors 150. A coprocessor 150 includes an I/O device, compression/decompression engine, hardware accelerator, peripheral component interconnect express (PCIe), network interface card, offload engine, or the like. According to at least one aspect, the core processors 150 are coupled to the intra-chip interconnect interface 120 through I/O bridges (IOBs) 140. As such, the coprocessors 150 are coupled to the core processors and the shared memory cache 110, or TADs, through the IOBs 140 and the intra-chip interconnect interface 110. According to at least one aspect, coprocessors 150 are configured to store data in, or load data from, the shared cache memory 110, or the TADs. The coprocessors 150 are also configured to send, or assign, processing tasks to core processors in the chip device 100, or receive data or processing tasks from other components of the chip device 100.

According to at least one example embodiment, the chip device 100 includes an inter-chip interconnect interface 130 configured to couple the chip device 100 to other chip devices. In other words, the chip device 100 is configured to exchange data and processing tasks/jobs with other chip devices through the inter-chip interconnect interface 130. According to at least one aspect, the inter-chip interconnect interface 130 is coupled to the core processors and the shared cache memory 110, or the TADs, in the chip device 100 through the intra-chip interconnect interface 120. The coprocessors 150 are coupled to the inter-chip interconnect interface 130 through the IOBs 140 and the intra-chip interconnect interface 120. The inter-chip interconnect interface 130 enables the core processors and the coprocessors 150 of the chip device 100 to communicate with other core processors or other coprocessors in other chip devices as if they were in the same chip device 100. Also, the core processors and the coprocessors 150 in the chip device 100 are enabled to access memory in, or attached to, other chip devices as if the memory was in, or attached, the chip device 100.

The architecture of the chip device 100 in general and the inter-chip interconnect interface 130 in particular allow multiple chip devices to be coupled to each other and to operate as a single system with computational and memory capacities much larger than that of the single chip device 100. Specifically, the inter-chip interconnect interface 130 together with a corresponding inter-chip interconnect interface protocol, defining a set of messages for use in communications between different nodes, allow transparent sharing of resources among chip devices, also referred to as nodes, within a multi-chip, or multi-node, system. Example embodiments of the multi-chip system and the inter-chip interconnect interface are described in more detail in U.S. patent application Ser. No. 14/201,541 entitled “Method and System for Work Scheduling in a Multi-chip System,” which is incorporated herein by reference in its entirety.

In a chip device, e.g., chip device 100, including one or more core processors and one or more coprocessors 150, the one or more core processors, and software executing thereon, communicate with the one or more coprocessors. In general, a coprocessor is a hardware component configured to perform specific processing tasks in order to offload the core processors. As such, communications between a core processor and a coprocessor involves sending commands, or instructions, from the core processor to the coprocessor direction and receiving corresponding response(s) from the coprocessor.

Existing techniques for exchanging commands and responses between a core processor and coprocessor include an input/output (I/O) store/load approach and a memory-based approach. In the I/O store load approach, commands from a core processor to a coprocessor are implemented using I/O store instruction(s) and an I/O memory-mapped address. For responses, e.g., from a coprocessor to a core processor, I/O load instruction(s) are used. I/O instructions allow moving data directly between core processors and coprocessors. As such, the I/O store/load approach provides high-performance. However, I/O instructions are generally limited to some small maximum width set by an instruction stream architecture supported by the processor, e.g., 64-bits size. As a result, transactions wider than the maximum size for I/O instructions are not atomic. That is, such transactions are not guaranteed to execute completely without being interrupted by other transactions. For example, assuming 64-bit I/O instructions are supported by the chip device 100, a 256-bit command is split into four 64-bit pieces. As such, a first agent, e.g., software agent, may be half-way through writing a command when a second agent is swapped in the core processor. Hence, the lack of atomicity results in virtualization problem(s). In fact, for wide commands to execute properly, a mechanism for storing partial commands, e.g., a subset of the 64-bit pieces from the first agent, in the core processor or coprocessor. Such mechanism adds to hardware, and/or software, complexity in the chip device 100.

In the memory-based approach, commands' implementation includes (1) the core processor writes a command to a storage location in memory, or cache memory, and (2) the coprocessor reads the command from the storage location. For responses, (1) the coprocessor writes a response in the storage location, and (2) the core processor reads the response from the storage location. A typical example is a doorbell exchange where a core processor writes a command to the storage location then writes to an I/O address in the coprocessor to indicate that the command is ready in the storage location. The coprocessor then reads the data stored by the core processor from the storage location. As such, the memory based approach allows large transactions, e.g., as large as the size of the storage location, to be supported. However, the memory-based approach involves moving data between a storage system, e.g., the shared cache memory 110 or external memory, and the coprocessor. Exchanging data through the storage system is obviously less efficient and slower than moving the directly from the core processor to the coprocessor. Using the doorbell described above there are four transactions; (1) the core processor storing command in the storage location, (2) the core processor informing the coprocessor about the stored command, (3) the coprocessor requesting the command from the storage location, and (4) the storage location sending the command to the coprocessor. In contrast, the I/O store/load approach makes use of a single transaction.

In the following, example embodiments of a method and system for exchanging a wide command, e.g., larger than maximum size of I/O instructions or having a response wider than a data word, in a single transaction in each direction, between the core processor and the coprocessor, are described.

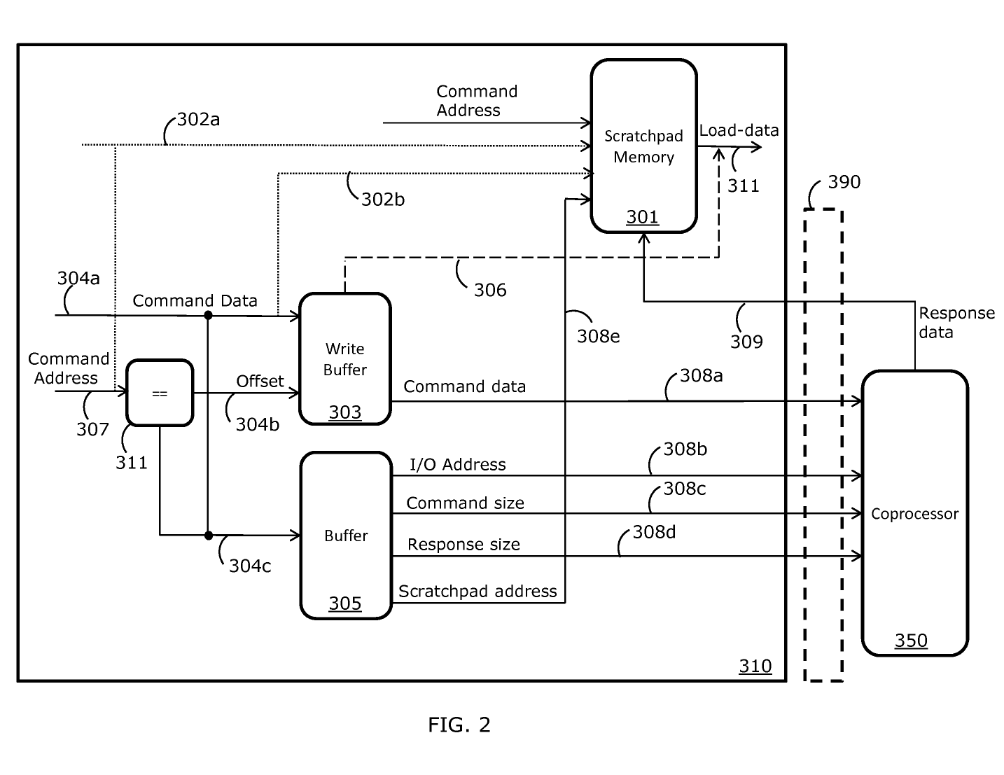

FIG. 2 is a block diagram illustrating exchange of data between a core processor 310 and a coprocessor 350, according to at least one example embodiment. According to at least one aspect, the core processor 310 includes a first storage component 301, e.g., one or more buffers, one or more memory locations, or the like, for storing response data received from the coprocessor 350. The first storage component 301 is also referred to herein as the scratchpad 301.

A person skilled in the art should appreciate that the first storage component 303 may be named differently. A person skilled in the art should appreciate that names used herein for hardware, or software, components, instructions/commands, etc., are not to be interpreted as limiting the scope of embodiments described herein. Other names, other than the ones provided herein, for such hardware, or software, components, instructions/commands, etc., may be used.

According to at least one aspect, the scratchpad 301 is writable by the core processor 310. That is, the core processor 310 may be configured to write, for example, an address or data associated with an instruction, or command, into the scratchpad 301, as indicated by the paths 302a and 302b, respectively. According to at least one aspect, the scratchpad 301 includes multiple storage locations, and, as such, is configured to store data associate with multiple commands simultaneously. Having storage capacity enough to store data associated with multiple commands in the scratchpad 301 allows multiple transactions, between the core processor 310 and the coprocessor 350, to be outstanding simultaneously. According to at least one aspect, the scratchpad 301 resides in the data cache (D-cache) of the core processor 310.

According to at least one example embodiment, the core processor 310 includes a second storage component 303, e.g., one or more write buffers, a portion of a write buffer, one or more memory/cache lines, one or more memory locations, storage area associated with a range of memory addresses, or the like. In a command transfer process, the core processor 310 stores command data into the second storage component 303, as indicated by 304a. The second storage component 303 may be associated with a fixed address or a programmable address. According to at least one aspect, the second storage component 303 includes multiple buffers or data lines that are associated with corresponding fixed, or programmable, addresses. For example, the second storage component 303 includes multiple memory/cache lines, where data associated with a given command being stored in a single data/cache line and no memory/cache line stores data for more than one command. Alternatively, the second storage component 303 includes a single memory/cache line, and, as such, allows data storage for a single command.

According to at least one aspect, an enable flag is employed to disable the command exchange process between the core processor 310 and the coprocessor 350. In particular, when the enable flag is not set, data stored in the second storage component 303 is caused to trap to an operating system (OS) or hypervisor. That is, execution of the command exchange process is stopped from continuing, and a different code starts executing.

According to at least one aspect, command data is stored in the second storage component 303 for later handling based on an address offset of the store operation. For example, if the command has a 16-byte size, the core processor 310 performs a sequence of store operations to the second storage component 303, including writing 304b an address offset multiple times, to complete storage of the 16-bytes of command data in the second storage component 303. The hardware component 311 is configured to extract address offset information 304b from command address 307 and pass it to the second storage component 303. According to at least one aspect, the size of each command is less than or equal to the size of cache line of data.

According to at least one example embodiment, a hypervisor, or operating system (OS), is allowed to interrupt storing command data to the second storage component 303. According to a first aspect, when interrupting the process of storing command data to the second storage component 303, the hypervisor, or OS, is configured to cause reading of the portion of command data already stored in the second storage component 303, and saving 306 the data read from the second storage component 303 in memory, e.g., the core processor’ L1 cache, shared cache memory 110, or external memory. Before resuming the original process of sending the command to the coprocessor 350, the second storage data 303 is restored by writing the data saved in memory, from the second storage component, back to the second storage component. According to a second aspect, if the second storage component is associated with a programmable address, the hypervisor, or OS, may change the second storage component's address to a new address to prevent processes from conflicting. For example, when a first command transfer process, using a first address for the second storage component 303, is interrupted and a second command transfer process is started, a second address is used for the second storage component 303.

According to at least one example embodiment, the core processor 310 stores 304c command-related information into a third storage component 305 within the core processor 310. According to at least one aspect, the third storage component 305 includes one or more write buffers, a portion of a write buffer, one or more memory/cache lines, one or more memory locations, storage area associated with a range of memory addresses, or the like. The information stored in a third storage component 305 includes an I/O address, command size, expected response size, and/or an address associated with the scratchpad 301. According to at least one aspect, the I/O address is indicative of which coprocessor is to receive the command and supply the response data. The I/O address may also indicate other information to the coprocessor 350, such as, which command is to be executed by the coprocessor 350.

The I/O address may be a physical address, or a virtual address subject to the memory address translation and exception handling. The command size is indicative, for example, of a number of bytes in the command. According to at least one aspect, the command size is a non-zero integer otherwise an error may occur causing an instruction trap to the OS/hypervisor. The expected response size indicates, for example, a number of bytes in the expected response. The response size may be zero to indicate that no response is expected. In the case where there are a multiple addresses, or cache lines, associated with the scratchpad 301, the address associated with the scratchpad 301 is used to indicate an where the response is to be stored in the scratchpad 301. The address associated with the scratchpad 301 and/or the response size may be optional.

According to at least one example embodiment, the command-related information is determined by the core processor 310 based on the command data 304a and a corresponding address 307. For example, the I/O address may be extracted from the address 307 associated with the command by the hardware component 311. Since the I/O address may include other information, such as, an identification of the command, such identification may be extracted from the command data 304a. Also, the command size is determined based on the command data. The response size may be determined based on the command data 304a or address 307. The address associated with the scratchpad 301 may be inserted in the command data by a software running in the core processor 310, and, as such, may be extracted from the command data. The hardware component 311 is configured to extract information, e.g., I/O address, command size, response size, address offset or scratchpad address, from address 307 and pass the extracted information to the second storage component 303 and the third storage component 305.

According to at least one example embodiment, the core processor 310 then causes the command data 308a and the information associated with the command 308b-308d to be sent to the coprocessor 350. The address associated with the scratchpad 301 may be maintained within the core processor 310 and simply transferred from the third storage component 305 to the scratchpad 301 as indicated by 308e. Alternatively, the address associated with the scratchpad 301 is passed to the coprocessor 350 and returned unmodified by the coprocessor 350. According to at least one aspect, by sending the command size to the coprocessor 350, the coprocessor 350 is made aware, for example, of how many bytes to expect in the command data, especially, if the command data is transferred to the coprocessor 350 as multiple data chunks, or multiple store/write commands.

According to at least one aspect, the command size is sent to the coprocessor 350 as part of address bits of a store command by the third storage component 305. According to at least one aspect, an enable flag is associated with third storage component 305. If the enable flag associated with the third storage component 305 is not set, load/store operations to third storage component 305 are caused to trap to an OS or hypervisor.

According to at least one example embodiment, the coprocessor executes the command upon receiving the command data 308a, and the command-related information, e.g., 308b-308d. The coprocessor 350 then writes 309 response data associated with the executed command, if any, to the scratchpad 301. If the address associated with scratchpad 301 is used, the response data is written to such address in the scratchpad 301. For example, if the address associated with scratchpad 301 is passed to the coprocessor 350, the coprocessor 350 may send such address to the core processor 310 when writing the response data to the scratchpad 301. Alternatively, if the address associated with the scratchpad 301 is sent directly to the scratchpad 301, as indicated in 308e, the coprocessor 350 sends 309 the response data to the core processor 310, which is directs the response data to the address associated with the scratchpad 301.

According to at least one aspect, once the response data is stored in the scratchpad 301, the software running on the core processor 310 uses a load operation/command to retrieve the response data from the scratchpad 301. According to at least one aspect, the software may be made aware that the response data is in the scratchpad 301 using a flag. That is, before the command-related information is stored to the third storage component 305, the software stores to the scratchpad's response location, or the address associated with the scratchpad 301, a value of the flag indicating no response is stored in the location. When the response data is stored to the scratchpad 301, the software overwrites the flag value, with a value different from “no-response” value, to indicate the presence of the response in the scratchpad 301. When the software detects the change in the flag value, the software is made aware of the presence of the response data in the scratchpad 301, and, as such, is allowed to load the response data from the scratchpad 301.

Alternatively, the core processor 310 may be configured to prevent load instructions from completing to any address that matches any scratchpad address waiting for a response. According to another aspect, the core processor 310 may employ a synchronization (SYNC) instruction to stall other instructions when the process of transferring the command to the coprocessor 350, and executing the command by the coprocessor 350, is still in progress, e.g., no response is written yet to the scratchpad 301. According to yet another aspect, the core processor employs readable status bit(s) to indicate when the process of transferring the command to the coprocessor 350, and executing the command by the coprocessor 350, is still in progress or is complete. The software may poll such readable bit(s) to determine if the process of transferring the command to the coprocessor 350, and executing the command by the coprocessor 350, is still in progress or complete. According to even another aspect, an interrupt may be used to inform the software that the process of transferring the command to the coprocessor 350, and executing the command by the coprocessor 350, is still in progress or complete. That is, the core processor 310 waits for the interrupt and receives the interrupt when that the process of transferring the command to the coprocessor 350, and executing the command by the coprocessor 350, is complete.

According to at least one example embodiment, the core processor 310 and the coprocessor 350 reside in different chip devices of a multi-chip system. In such case, an inter-chip interconnect interface 390 is employed to enable cross-chip communications. That is, communications, e.g., 308a-308d, and 309, between the core processor 310 and the coprocessor 350 are handled through the inter-chip interconnect interface 390.

According to at least one example embodiment, a logical I/O protocol, also referred to as the I/O space protocol, is configured to handle I/O traffic within a chip device, e.g., 100, or within a multi-chip system. A person skilled in the art should appreciate that the core processor 310 and the coprocessor 350 may both reside on the same chip device 100 or may be located in different chip devices within the multi-chip system.

According to at least one aspect, example embodiments of handling wide commands between a core processor 310 and a coprocessor 350, as described with respect to FIG. 2, are implemented using messages, or commands, defined within the logical I/O protocol. Each I/O protocol message is either a request (IOReq message) or a response (IORsp message). The requests include simple scalar read and write operations as well as atomic read, write-only, and atomic read-write vector operations. The IORsp messages are used to send responses for the IOReq messages.

According to at least one example embodiment, one or more I/O protocol messages/commands are defined in way to handle wide commands between the core processor 310 and the coprocessor 350. For example, a first command, referred to herein as IOBDMA operation, is configured to cause an address to be sent from the core processor 310, e.g., from the second storage component 303 or the third storage component 305, to the coprocessor 350 and cause a variable-length response to be returned from the coprocessor 350 to the core processor 310, e.g., to the scratchpad 301. As such, the IOBDMA operation may be viewed as a multi-word load operation. That is, the IOBDMA operation allows the corresponding response to be larger than a size of a word, e.g., a 64-bit word, supported by the chip device 100 or the multi-chip system 600. The response, if wider than the size of the word, is sent to the core processor 310 over multiple data transfers each transferring a single word, e.g., 64-bit word. According to at least one aspect, the response is a sequence of words with a maximum length for the response being equal to the size of a cache line, e.g., 128 bytes.

A second operation, referred to herein as LMTST operation, causes an address and a variable-length vector of data to be sent from the core processor 310 to coprocessor 350. The LMTST operation may be viewed as a multi-word store operation. According to at least one aspect, the address sent to the coprocessor 350 is be sent from the third storage component 305, whereas the variable-length data is sent from the second storage component 303. When the LMTST operation is used, no response is written to the scratchpad 301. The variable-length vector of data, if wider than the size of the word, is sent to the coprocessor 350 over multiple data transfers each transferring a single word, e.g., 64-bit word. According to at least one aspect, the variable-length vector of data is a sequence of words with a maximum length for such vector being equal to the size of a cache line, e.g., 128 bytes.

According to at least one aspect, a third operation, referred to herein as LMTDMA operation, causes an address and a variable-length vector of data to be sent, respectively, from the third storage component 305 and the second storage component 303, to the coprocessor 350, and cause a variable length response to be sent from the coprocessor 350 to the scratchpad 301. The variable-length vector of data, if wider than the size of the word, is sent to the coprocessor 350 over multiple data transfers each transferring a single word, e.g., 64-bit word. Also, the response, if wider than the size of the word, is sent to the core processor 310 over multiple data transfers each transferring a single word, e.g., 64-bit word. According to at least one aspect, both the variable-length vector of data and the response are sequences of words, with each sequence having a maximum length equal to the size of a cache line, e.g., 128 bytes.

A person skilled in the art should appreciate that the names of the operations mentioned above is not to be interpreted as limiting the scope of embodiments described herein. Other names for such operations may be used. A person skilled in the art should also appreciate that the three operations, IOBDMA, LMTST, and LMTDMA, described above, illustrate example embodiments of wide commands, from the core processor 310 to the coprocessor 350, having, respectively, no command data, no response data, and command data and response data. That is, the IOBDMA operation corresponds to a special case of embodiments described with respect to FIG. 3 where no command data is sent from the second storage component 303 to the coprocessor. The LMTST operation corresponds to a special case of embodiments described with respect to FIG. 3 where no response data is sent from the coprocessor 350 to the scratchpad 301. The LMTDMA operation, however, includes sending 308a command data from the core processor 310 to the coprocessor 350 and sending 309 response data from the coprocessor to the scratchpad 301.

While this invention has been particularly shown and described with references to example embodiments thereof, it will be understood by those skilled in the art that various changes in form and details may be made therein without departing from the scope of the invention encompassed by the appended claims.

What is claimed is:

1. A method of processing a wide command comprising:
storing wide command data in a first physical structure of a processor;
determining information associated with the wide command based on the wide command data or a corresponding memory address range associated with the first physical structure of the processor, the information determined including a size of the wide command;
storing the information determined in a second physical structure of the processor; and
causing the first physical structure and the second physical structure to provide the wide command data and the information associated with the wide command directly to a coprocessor for executing the wide command.

2. The method as recited in claim 1 further comprising executing the wide command by the coprocessor.

3. The method as recited in claim 2 further comprising providing a response to the processor by the coprocessor upon executing the wide command, the response being stored in a third physical structure of the processor.

4. The method as recited in claim 3 further comprising:
storing in the third physical structure an indication of no response prior to storing the information associated with the wide command in the second physical structure; and
overwriting the indication of no response with an indication of a complete response upon the response being completely stored in the third structure, access to the response being provided only after the indication of no response is overwritten with the indication of a complete response.

5. The method as recited in claim 3 further comprising preventing, by the processor, access to any address of the third physical structure associated with the response before the response is completely stored in the third structure.

6. The method as recited in claim 3 further comprising:
implementing a synchronization operation by the processor;
preventing, by the processor, the synchronization operation and any subsequent operations from executing before the response is completely stored in the third physical structure.

7. The method as recited in claim 3 further comprising:
providing, by the processor, an indication of a status of the wide command; and
providing access to a memory address associated with the response in the third physical structure only if the indication of the status indicates that the wide command is completed.

8. The method as recited in claim 1, wherein the information associated with the wide command further includes an address referencing the coprocessor.

9. The method as recited in claim 8, wherein the information associated with the wide command further includes a size of a response and an address of a third physical structure for storing the response in the processor.

10. The method as recited in claim 1, wherein the first physical structure includes at least one of a write buffer and a dedicated physical structure.

11. The method as recited in claim 1, wherein the processor and the coprocessor reside in a single chip device.

12. The method as recited in claim 1, wherein the processor and the coprocessor reside in different chip devices of a the multi-chip system.

13. An apparatus comprising:
a coprocessor; and
a processor including a first physical structure and a second physical structure, the processor configured to:
store wide command data in the first physical structure of a processor;
determine information associated with the wide command based on the wide command data or a corresponding memory address range associated with the first physical structure of the processor, the information determined including a size of the wide command;
store the information determined in the second physical structure of the processor; and
cause the first physical structure and the second physical structure to provide the wide command data and the information associated with the wide command directly to the coprocessor for executing the wide command.

14. The apparatus as recited in claim 13, wherein the coprocessor is configured to execute the wide command.

15. The apparatus as recited in claim 14, wherein the coprocessor is further configured to provide a response to the processor upon executing the wide command, the processor further including a third physical structure and further configured to store the response in the third physical structure.

16. The apparatus as recited in claim 15, wherein the processor is further configured to:
store in the third physical structure an indication of no response prior to storing the information associated with the wide command in the second physical structure; and
overwrite the indication of no response with an indication of a complete response upon the response being completely stored in the third structure, access to the response provided only after the indication of no response is overwritten with the indication of a complete response.

17. The apparatus as recited in claim 15, wherein the processor is further configured to prevent access to any address of the third physical structure associated with the response before the response is completely stored in the third structure.

18. The apparatus as recited in claim 15, wherein the processor is further configured to:
implement a synchronization operation;
prevent the synchronization operation and any subsequent operations from executing before the response is completely stored in the third physical structure.

19. The apparatus as recited in claim 15, wherein the processor is further configured to:
provide an indication of a status of the wide command; and
provide access to a memory address associated with the response in the third physical structure only if the indication of the status indicates that the wide command is completed.

20. The apparatus as recited in claim 13, wherein the information associated with the wide command further includes an address referencing the coprocessor.

21. The apparatus as recited in claim 20, wherein the information associated with the wide command further includes a size of a response and an address of a third physical structure for storing the response in the processor.

22. The apparatus as recited in claim 13, wherein the first physical structure includes at least one of a write buffer and a dedicated physical structure.

23. The apparatus as recited in claim 13, wherein the apparatus is a chip device.

24. The apparatus as recited in claim 13, wherein the apparatus is a multi-chip system including multiple chip devices.

25. The apparatus as recited in claim 24, wherein the processor and the coprocessor reside in different chip devices, of the multiple chip devices, in the multi-chip system.
